(19) United States
(12) Patent Application Publication
(10) Pub. No.: US 2018/0336872 A1
(43) Pub. Date: Nov. 22, 2018

(54) DEVICE AND METHOD FOR ENHANCING INDIVIDUAL PARTICIPATION IN THE RHYTHMIC ARTS

(71) Applicant: Thomas M. Shoaff, Fort Wayne, IN (US)

(72) Inventor: Thomas M. Shoaff, Fort Wayne, IN (US)

(21) Appl. No.: 15/978,723

(22) Filed: May 14, 2018

Related U.S. Application Data
(60) Provisional application No. 62/507,487, filed on May 17, 2017.

(51) Int. Cl. G10H 3/14; G10H 1/00; G10H 1/32

(52) U.S. Cl. CPC G10H 3/143; G10H 2220/185; G10H 1/32; G10H 1/0008

(57) ABSTRACT

A device and method for enhancing individual participation in the rhythmic arts by generating feedback sounds for individual rhythmic performers, such as dancers or players of musical instruments, that help coordinate the movements and/or actions of the individual performers as if the individual performers were performing along with other performers in a group. In this manner, the present device and method helps rhythmic performers practice their techniques individually by simulating a performance within a group.

### CROSS-REFERENCE TO RELATED APPLICATIONS

This application claims priority to U.S. Application No. 62/507,487 filed May 17, 2017, the entire disclosure of which is hereby explicitly incorporated by reference herein.

### BACKGROUND

### 1. Field of the Invention

The present invention relates to a device and method for enhancing individual participation in the rhythmic arts, such as music and dance, which require precision and coordination in a group setting.

### 2. Description of the Related Art

In the rhythmic arts, a person may practice a dance routine or play a musical instrument, for example, in preparation for a performance within a larger group. Even though practice and development in group settings is possible, practicing to perfection also requires working individually. Individual practice allows performers to fine-tune and master their techniques by addressing their individual weaknesses.

However, individual practice often lacks the stimulation and development that group practice provides because the rhythmic arts usually involve performers coordinating and harmonizing their sounds with those of others. Presently, individual practice provides no such opportunity for sound coordination or harmonization.

The rhythmic arts would benefit from a way to facilitate and enhance individual practice and which also fine-tunes performance within a larger group.

### SUMMARY

The present disclosure provides a device and method for enhancing individual participation in the rhythmic arts by generating feedback sounds for individual rhythmic performers, such as dancers or players of musical instruments, that help coordinate the movements and/or actions of the individual performers as if the individual performers were performing along with other performers in a group. In this manner, the present device and method helps rhythmic performers practice their techniques individually by simulating a performance within a group.

In one embodiment, the present method provides dancers with a feedback mechanism to coordinate movement as if performing as part of a group. In particular, a dancer wearing a shoe having a pickup device repeatedly strikes a surface, and the system provides a sound feedback which is proportional to the strike force on the surface and/or which is coordinated with similar sounds to generate a simulated group sound. In another embodiment, the present method provides a percussion artist with a feedback mechanism to coordinate rhythmic beats. In particular, a percussion artist applies a force to a percussion device using a pickup device which transmits a signal, and the system provides a sound feedback which is proportional to the strike force of the pickup device and/or which is coordinated with similar sounds to generate a simulated group sound.

In sum, the present device and method provides feedback sounds that simulate a group setting for performers that are practicing alone, in order to facilitate individual improvement along with group harmonization and coordination while accommodating the needs or schedule of the individual performer.

In one form thereof, the present invention provides a device for use in practice of a rhythmic art, including a sensor-transmitter module, including a pickup device operable to generate a first signal proportional to an impact received by the pickup device; and a transmitter operable to transmit the first signal; and a receiver-speaker module, including a receiver operable to receive the signal from the transmitter; a sound module operable to generate at least one second signal substantially similar to the first signal; and at least one speaker operable to convert the first and second signals into sound.

The pickup device may include a sensor in the form of a piezo electric material which is responsive to an applied force. The piezo electric material may be at least one piezo crystal selected from the group consisting of zirconate titanate, gallium phosphate, quartz, tourmaline, and lead magnesium, niobate-lead tianate, and combinations thereof. The piezo electric material may be operable to generate the first signal in proportion to an amount of force applied to the piezo electric material. The first signal may be an infrared signal.

The sound module may be operable to transmit the second signal to the speaker at least one of immediately prior to, directly along with, or immediately after, the first signal. The sound module may be operable to generate and transmit a plurality of second signals to the speaker at least one of immediately prior to, directly along with, or immediately after, the first signal. The sound module is operable to generate the at least one second signal which differs from the first signal in at least one of frequency, volume, and tone.

The sensor-transmitter module may be integrated into a shoe, a drumstick, or a drum, for example.

### BRIEF DESCRIPTION OF THE DRAWINGS

The above-mentioned and other features and advantages of this disclosure, and the manner of attaining them, will become more apparent and the invention itself will be better understood by reference to the following description of an embodiment of the invention taken in conjunction with the accompanying drawings, wherein:

FIG. 1 is schematic representation of a system in accordance with the present invention;

FIG. 2 is a view of a shoe including a first pickup device;

FIG. 3 is a view of a shoe including a second pickup device;

FIG. 4 is a view of another pickup device in the form of a drum;

FIG. 5 is a view of another pickup device in the form of a xylophone;

FIG. 6 is a view of a drumstick including a pickup device; and

FIG. 7 is a view of a xylophone mallet including a pickup device.

Corresponding reference characters indicate corresponding parts throughout the several views. The exemplifications set out herein illustrate an exemplary embodiment of the invention, and such exemplifications are not to be construed as limiting the scope of the disclosure in any manner.

### DETAILED DESCRIPTION

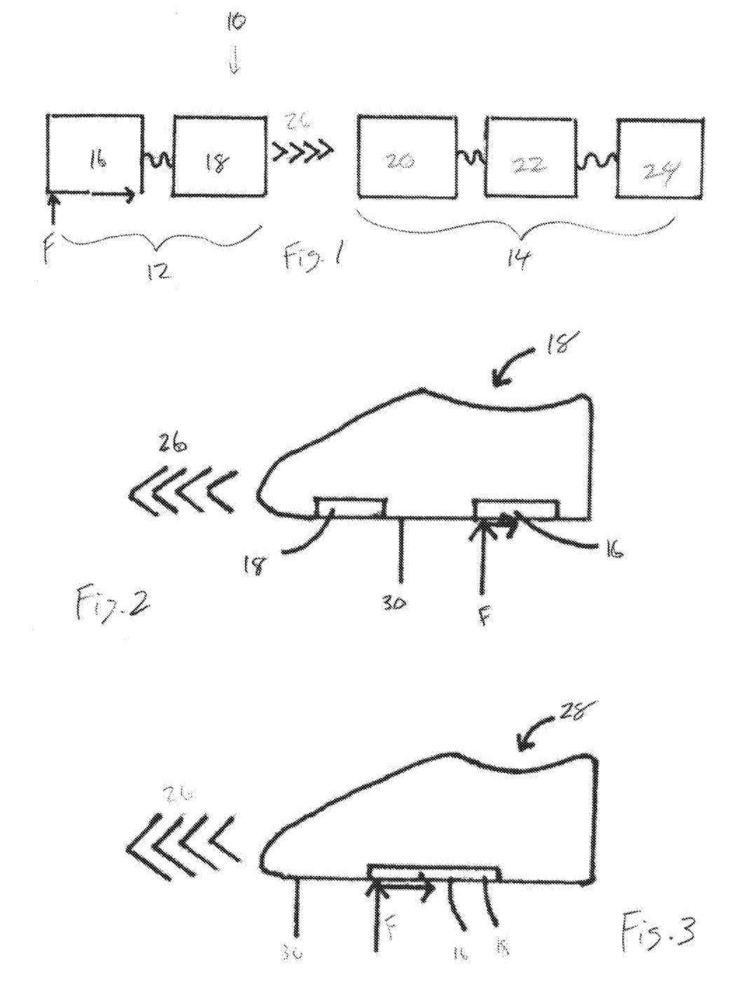

Referring to FIG. 1, an embodiment of system 10 is shown. System 10 combines two general components, a pickup device in the form of sensor-transmitter module 12, and a feedback device in the form of receiver-speaker module 14. As discussed in further detail below, sensor-transmitter module 12 may be worn by the performer or contained in a musical instrument being played by the performer. As will be apparent from the discussion below, functionally similar devices may be substituted for the various disclosed components described below, and the functionality of the system is not limited to those devices and components specifically disclosed.

Sensor-transmitter module 12 may include two components, sensor 16 and transmitter 18. Generally, a performer applies force F to sensor 16 and sensor 16 converts force F to a signal, which is transmitted by transmitter 18. Sensor 16 and transmitter 18 may be connected physically to each other and reside in a single unit, or may be separate from one another and connected wirelessly, for example.

Receiver-speaker module 14 may include three components. Receiver 20 receives signal 26 from transmitter and sends signal 26 to sound module 22. Receiver 20 may connect to sound module 22 either physically or wirelessly. Sound module 22 then processes signal 26 and sends signal 26 to speaker 24 via a physical or wireless connection, where signal 26 is converted to sound and emitted.

Sensor 16 may include a Piezo crystal which may be of several different types of materials, such as lead zirconate titanate (PZT ceramic), gallium phosphate, quartz, tourmaline, lead magnesium niobate-lead titanate, etc. A musical instrument pick-up may employ a Piezo crystal element that senses transverse, longitudinal, and sheer forces applied to it.

When experiencing force F, Piezo electric material experiences a mechanical deformation displacing charges throughout the material. This charge displacement is highly proportional to force F applied. The ability of sensor 16 to distinguish between different degrees of force F and the corresponding charge displacement translate into the production of different sounds based on various forces applied to sensor 16. For example, the harder one strikes sensor 16, the louder the sound that comes out of speaker 24.

The magnitude of the charge displacement determines the magnitude of signal the transmitter emits. After each applied force F on sensor 16, transmitter 18 transmits signal 26 to receiver 20 of receiver-speaker module 14 immediately in order to maintain a constant sound feedback to the performer. This immediate sound feedback helps the performer coordinate and harmonize similar to the way different performing group members would react to each other's sounds. Signal 26 may be radio, infrared, Bluetooth, etc.

Receiver 20 receives the same type of signal 26 that transmitter 18 emits and is compatible with transmitter. For example, system 10 may employs an infrared transmitter and a corresponding infrared receiver.

Sound module 22 may convert signal 26 into a similar sound as the one performer produces, or one completely different, depending on the requirements of the given rhythmic art. Sound module 22 may convert signal 26 into one of several different frequencies, volumes, and tones and can imitate other instruments or sound effects. To accommodate the desires of different performers, sound module 22 may include a synthesizer, sampler, rompler, etc., and may be selectively adjustable and configurable based on performer input.

In one embodiment, sound module 22 may simply mimic and amplify the sound made by the performer. For example, a drummer may hear the amplified sound of the drummer's own beat as audible feedback in real time.

In another embodiment, sound module 22 may overlay or superimpose one or more substantially identical sounds as part of the audible feedback. For example, a drummer may hear a real-time audible feedback corresponding to the drummer's own beat, along with the sound of substantially identical beats that are sounded immediately prior to, directly along with, and/or immediately after, the drummer's own beat in order to simulate the sound of a group. In this manner, the system may operate to generate a group feedback sound for the performer based only on the single input from the performer. Similarly, a small group of performers may use the present system to receive a feedback sound simulating that of a larger group.

Speaker 24 emits sounds as audible feedback for the performer. Speaker 24 may be a freestanding device separate from the performer or one that the performer wears, such as headphones, depending on the noise allowance and space available at the performer's practice location.

In sum, system 10 features two general components. The first component, sensor-transmitter module, generally includes sensor 16 and transmitter 18. Sensor accepts force F, sends signal to transmitter 18, and transmitter 18 emits signal 26. The second component, receiver-speaker module 14, generally includes receiver 20, sound module 22, and speaker 24. A receiver 20 compatible with transmitter 18 accepts signal 26, sends signal 26 to sound module 22, and sound module 22 converts signal 26 into a usable and desirable sound. Speaker 24 emits the sound for the performer to hear.

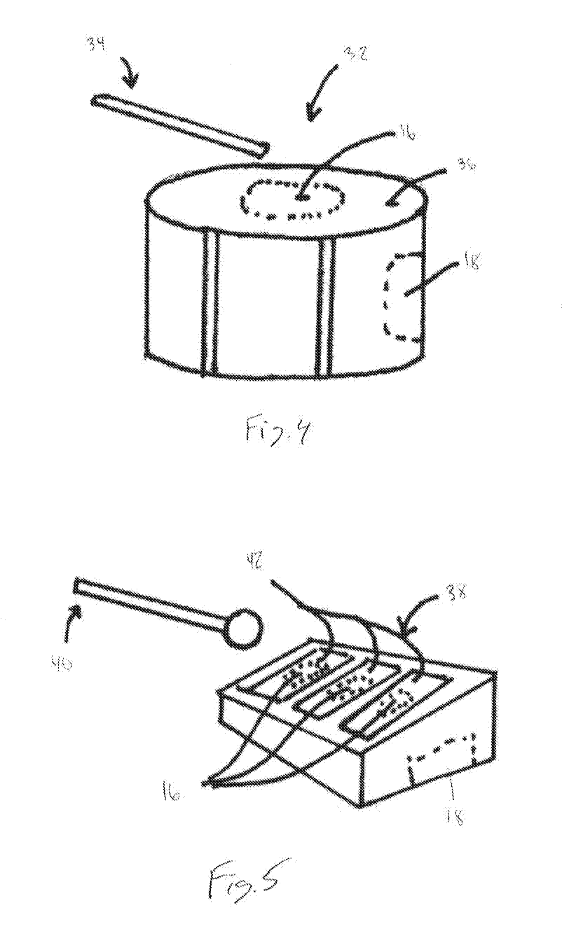

Referring to FIG. 2, a first embodiment of the sensor-transmitter module of the present system is shown as shoe 28. Sensor 16 is embedded as either a permanent component or a temporary insert in sole 30 and works in conjunction with transmitter 18. While sensor 16 should be positioned within sole 30, transmitter 18 can be positioned anywhere within range of both sensor 16 and receiver 20. As shown in FIG. 3, sensor 16 and transmitter 18 can also be combined into a single component to save space and increase efficiency. A performer applies force F to sole with an action such as a tap or a stomp to trigger sensor and generate signal 26 through transmitter 18. The magnitude of force F the performer applies to shoe 28 is determines the sound produced by the sound module 22 to help coordinate further movements.

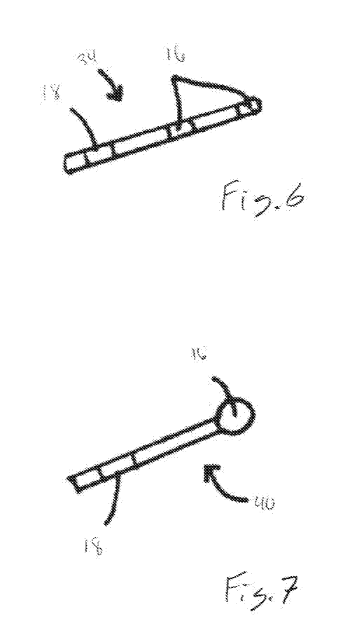

Referring to FIGS. 4 and 5, second and third embodiments of the sensor-transmitter modules of the present system are shown as percussion instruments. Sensor 16 may be placed in a stationary surface such as within surface 36 of drum head 32 or within bar 42 of xylophone 38. FIGS. 6 and 7 show that sensor 16 may also be placed in drumstick 34 and mallet 40 used to strike surfaces 36 and bar 42, respectively. In the embodiments of FIGS. 4 and 5, sound transmission functions similar to shoe 28. The volume of the sound output from speaker 24 corresponds to the magnitude of force F with which either surface 36 of drum 32 or bar 42 of xylophone 38 is struck.

While this invention has been described as having an exemplary design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A device for use in practice of a rhythmic art, comprising:
a sensor-transmitter module, comprising:
a pickup device operable to generate a first signal proportional to an impact received by the pickup device; and
a transmitter operable to transmit the first signal; and
a receiver-speaker module, comprising:
a receiver operable to receive the first signal from the transmitter;
a sound module operable to generate at least one second signal substantially similar to the first signal; and
at least one speaker operable to convert the first and second signals into sound.

2. The device of claim 1, wherein the pickup device comprises a sensor in the form of a piezo electric material which is responsive to an applied force.

3. The device of claim 2, wherein the piezo electric material is at least one piezo crystal selected from the group consisting of zirconate titanate, gallium phosphate, quartz, tourmaline, and lead magnesium, niobate-lead tianate, and combinations thereof.

4. The device of claim 2, wherein the piezo electric material is operable to generate the first signal in proportion to an amount of force applied to the piezo electric material.

5. The device of claim 1, wherein the first signal is an infrared signal.

6. The device of claim 1, wherein the sound module is operable to transmit the second signal to the speaker at least one of immediately prior to, directly along with, or immediately after, the first signal.

7. The device of claim 1, wherein the sound module is operable to generate and transmit a plurality of second signals to the speaker at least one of immediately prior to, directly along with, or immediately after, the first signal.

8. The device of claim 1, wherein the sound module is operable to generate the at least one second signal which differs from the first signal in at least one of frequency, volume, and tone.

9. The device of claim 1, wherein the sensor-transmitter module is integrated into a shoe.

10. The device of claim 1, wherein the sensor-transmitter module is integrated into a drumstick.

11. The device of claim 1, wherein the sensor-transmitter module is integrated into a drum.
